(19) United States
(12) Patent Application Publication
(10) Pub. No.: US 2026/0314862 A1
(43) Pub. Date: Oct. 15, 2026

(54) SCREW, JUICING ASSEMBLY AND JUICER

(71) Applicant: Guangdong Fresh Smart Technology Co., Ltd., Foshan (CN)

(72) Inventor: Wenfei LI, Foshan (CN)

(21) Appl. No.: 19/464,818

(22) Filed: Jan. 30, 2026

Related U.S. Application Data
(63) Continuation of application No. PCT/CN2025/080492, filed on Mar. 4, 2025.

(30) Foreign Application Priority Data
Jul. 31, 2024 (CN) 202421845418.8
Jul. 31, 2024 (CN) 202421845567.4
Jul. 31, 2024 (CN) 202421845696.3

(51) Int. Cl. A47J 19/02

(52) U.S. Cl. CPC A47J 19/025

(57) ABSTRACT

The present invention discloses a screw, a juicing assembly, and a juicer, the screw comprises a screw body, and the outer wall of screw body is provided with threads; the juicing assembly comprises a screw body, a pressure plate, a cutting blade, and a transmission shaft, the juicer comprises a main unit with a built-in power device, a juicing assembly, a feeding bin, and a juicing cylinder, the juicer includes the above-mentioned screw and juicing assembly, having the advantages of simplified manufacturing and assembly, reduced costs, etc.

### CROSS-REFERENCE TO RELATED APPLICATIONS

This application is a continuation of International Application No. PCT/CN2025/080492, filed on Mar. 04, 2025, which claims priority to Chinese Patent Application No. 202421845696.3, No. 202421845567.4 and No. 202421845418.8, filed with the China National Intellectual Property Administration on Jul. 31, 2024, all of which are hereby incorporated by reference in their entireties.

### TECHNICAL FIELD

The present invention relates to a screw, juicing assembly and juicer.

### BACKGROUND

In existing juicing equipment, the juicing cylinder and screw are usually composed of multiple components to achieve effective separation and discharge of juice and fruit residue. In an existing design of juice cylinder, for example, a separating screw is contained inside, and the screw includes the following two modules: the first module: including a hollow first body around which a plurality of slits extend along the length direction, and the second module: including a second main body that can be combined with the first main body in a loading and unloading manner. Ribs are formed on the second main body, and are inserted into the slits of the first main body.

The second module is combined with the first module to form a separation screw for juicing purpose, and the screw body has weak strength due to the structural reason of the screw body based on separation design. The juicing object is squeezed into juice and residue between the separation screw and the juicing cylinder, the juice flows into the interior of the separation screw through the gap between the convex ribs and the cutting seam, and is then discharged through the juice discharge groove, while the residue is discharged through the residue discharge groove.

This prior art which can separate juice and fruit residue, however, faces a complex design and manufacturing process, for example, the screw requires precise alignment and assembly of multiple components, increasing manufacturing costs and assembly difficulty

### SUMMARY

The first objective of the present invention is to provide a screw that simplifies manufacturing and assembly, and reduces costs.

The first purpose is realized as follows: a screw comprises a screw body, the outer wall of screw body is provided with threads; the inner cavity of screw body is provided with a juice collection chamber; a plurality of juice inlets communicating with the juice collection chamber are spaced on the outer wall of screw body. These small juice inlets which support residue separation can effectively filter fruit residue to provide purer juice and avoid the mixing of juice and residue in traditional juicers, improving the juice quality. Therefore, the screw body has a filtering function.

During juice extraction, the threads designed on the outer wall of screw body also help to enhance the squeezing effect, ensuring the continuity and stability of juice extraction. Therefore, the screw body has a squeezing function.

The use of juice collection chamber inside the screw body for direct collection and filtering of juice simplifies the structural design of the juicer (without the need for additional filters), reducing the complex process of separating the juice and fruit residue that fall onto the bottom of juicing chamber, minimizing the number of parts that need to be cleaned in the juicer, and making cleaning simpler and more efficient.

The first objective of the present invention can also be addressed by the following technical measures:

In further, the inner cavity of screw body is a hollow inner cavity, and the hollow inner cavity forms the juice collection chamber.

The hollow inner cavity designed in the screw body forms a juice collection chamber, allowing juice to directly enter the juice collection chamber during the squeezing process. Compared to traditional designs, this internal channel design reduces the path and resistance of juice flow, improving the efficiency of juice collection. The hollow inner cavity designed allows juice to collect in the inner cavity of screw body and enter the juice collection chamber through the juice inlet. These small juice inlets which support residue separation can effectively filter fruit residue to provide purer juice and avoid the mixing of juice and residue in traditional juicers, improving the juice quality. Designing a juice collection chamber in the hollow inner cavity of screw body helps simply the overall structural design of the juicer, reducing the use of external pipelines and components. This integrated design reduces manufacturing and maintenance costs and improves equipment reliability. The integrated design of the hollow inner cavity and juice collection cavity makes juice collection more centralized and convenient. When cleaning the juicer, users only need to clean the inner cavity and juice inlet of screw body, reducing the difficulty and time of cleaning and improving the convenience of use. The designed hollow inner cavity not only reduces the weight of screw body, but also reduces the inertia force of the equipment during high-speed operation, making the juicer run more smoothly, reducing vibration and noise, and improving equipment stability and user experience.

In further, a juice outlet is provided at a position on the bottom of screw body corresponding to the juice collection chamber.

The juice outlet designed at the bottom of screw body directly discharges juice from juice collection chamber to significantly shorten the juice squeezing-discharging path and time and improve the efficiency of juice discharge, ensuring the quick juice collection and preventing juice oxidation caused by prolonged juice extraction. The juice outlet designed at the bottom of screw body makes juice discharge more direct and thorough, reduces the residue and accumulation of juice inside the equipment, making it easy for users to clean and maintain, and improving the convenience of use. The design of bottom juice outlet enables smooth discharge of juice, reducing the risk of juice accumulation and blockage in the screw body cavity, ensuring long-term stable juicer operation, and reducing the failure rate.

In further, the juice inlet is a vertical or diagonal opening.

In further, the inner wall of screw body is provided with a V-shaped groove, the tip of the V-shaped groove communicates with the juice inlet, and the opening of the V-shaped groove faces and communicates with the juice collection chamber.

The opening of V-shaped groove on the inner wall of screw body faces and communicates with the juice collection chamber, enabling the smooth flow of juice to the juice collection chamber. The combination of juice inlet designed with a vertical or diagonal opening and V-shaped groove enables the quick extraction of juice and the entry to the juice collection chamber. This precise ingredient guidance and separation design improves the extraction efficiency and juice yield, ensuring higher juice production. The vertical or diagonal opening of juice inlet and the design of V-shaped groove simplify the cleaning process. The fruit residue which is mainly left in the V-shaped groove can be more easily removed during cleaning, reducing the difficulty and time of cleaning, and improving the convenience of use.

In further, the width of juice inlet is smaller than that of the opening of the V-shaped groove.

Because of the smaller width of juice inlet than the opening width of V-shaped groove, fruit residue cannot enter the juice collection chamber, effectively reducing the impact of fruit residue on juice quality and improving the taste and clarity of juice.

The second objective of the present invention is to provide a juicing assembly with a screw body, a pressure plate, and a cutting blade which are based on integrated design and more convenient installation and disassembly.

The above purpose is realized as follows: a juicing assembly comprises a screw body, a pressure plate, a cutting blade and a transmission shaft, the outer wall of screw body is provided with threads; the inner cavity of screw body is provided with a juice collection chamber; a plurality of juice inlets communicating with the juice collection chamber are spaced on the outer wall of screw body; the transmission shaft disposed in the inner cavity of screw body is integrally formed with the screw body, and the head of transmission shaft runs through the screw body and extends outward; the cutting blade is rotatably disposed on the pressure plate, and the pressure plate is connected to the screw body and located above the screw body; the head of transmission shaft runs through the pressure plate and is connected to the cutting blade, and the rotating transmission shaft enables the synchronous rotation of screw body and cutting blade.

During juice extraction, the power device drives the screw body to rotate, allowing the complete squeezing of fruits and vegetables in the squeezing area, thereby increasing the juice yield, and the threads designed on the outer wall of screw body also help to enhance the squeezing effect, ensuring the continuity and stability of juice extraction. Therefore, the screw body has a squeezing function. During juice extraction, the juice enters the juice collection chamber inside the screw body through the juice inlet on the outer wall of screw body. These small juice inlets which support residue separation can effectively filter fruit residue to provide purer juice and avoid the mixing of juice and residue in traditional juicers, improving the juice quality. Therefore, the screw body has a filtering function. The use of juice collection chamber inside the screw body for direct collection and filtering of juice simplifies the structural design of the juicer, reducing the complex process of separating the juice and fruit residue that fall onto the bottom of juicing chamber, minimizing the number of parts that need to be cleaned in the juicer, and making cleaning simpler and more efficient.

The cutting blade rotates synchronously with the screw body to initially cut the food entering the screw body, which can effectively chop large pieces of food, reduce the workload of screw body, and improve the efficiency of the entire pressing process. The pressure plate disposed above the screw body prevents the screw from moving upwards during juice extraction, thereby fixing the screw position and ensuring the stability of food during squeezing process, improving the juice yield and juice quality. Since the pressure plate disposed above the screw body prevents the screw from moving upwards during juice extraction, fixing the screw position, the power device drives the screw body and cutting blade to rotate synchronously through the power components and transmission shaft, so that the food can be fully cut and crushed before entering the screw body, reducing machine jamming, and improving the stability and continuity of the juicer.

The integrated design of screw body, cutting blade, and pressure plate allows users to easily disassemble and clean the entire juicing assembly after use, reducing the cleaning difficulties caused by the separation of multiple components in traditional juicers. In further, the assembly process is also simpler, and users can complete equipment assembly and disassembly without tedious operations, improving the convenience of use.

The integrated design reduces the connection and wear between assemblies, reduces the risk of equipment failure caused by loose or damaged components, enhances the overall safety and durability of the juicer, and extends the service life of equipment. Placing transmission shaft inside the screw body cavity and integrating the transmission shaft and screw body simplify the internal structural design of juicer, reduce the number and complexity of parts, thereby reducing manufacturing and maintenance costs.

The integrated design and optimized synchronous rotation mechanism make the juicer run more smoothly during operation, reduce mechanical noise, provide a quieter usage environment, and enhance the user experience.

The second objective of the present invention can also be addressed by the following technical measures:

In further, the juicing assembly further comprises a bolt and a wear-resistant sleeve, wherein the inner cavity of wear-resistant sleeve is provided with a connecting cavity that fits the shape of the head of transmission shaft; the pressure plate is provided with a socket, the wear-resistant shaft sleeve is disposed inside the socket, the upper end of the wear-resistant shaft sleeve is provided with an upper connecting clamp ring, the bottom of the cutting blade is provided with an upper connecting clamp cavity that fits the shape of the upper connecting clamp ring, the upper connecting clamp ring is inserted into the upper connecting clamp cavity, and the bolt runs through the cutting blade to lock the wear-resistant shaft sleeve, so as to connect the wear-resistant shaft sleeve with the cutting blade; the head of transmission shaft is inserted into the connecting cavity, and the bolt locks the head of transmission shaft to connect the cutting blade, pressure plate, and screw body together.

The wear-resistant shaft sleeve inside the socket has excellent wear resistance and can effectively reduce the friction and wear between the transmission shaft and the pressure plate, prolong the service life of the juicer, and improve the reliability of the equipment.

The head of transmission shaft tightly fits with the wear-resistant shaft sleeve through the connecting cavity, and the bolt passes through the cutting blade and locks the wear-resistant shaft sleeve, ensuring a stable connection between the cutting blade, the pressure plate, and the screw body. The stable connection structure avoids the loosening and displacement of components during operation, improving the stability and safety of the juicer.

The designed upper connecting clamp ring and upper connecting clamp cavity enables the quick installation of cutting blade on the wear-resistant shaft sleeve, and the head of transmission shaft is locked with bolts to realize rapid assembly and disassembly. The stable connection and wear-resistant design ensure that the cutting blade can effectively perform preliminary cutting treatment on the food during rotation, improve the pressing efficiency of the food entering the screw body, and ensure efficient juice yield. The application of wear-resistant parts reduces the wear between the transmission shaft and other components, lowers the jamming and equipment failure rate caused by wear, and improves the overall performance and user experience of the juicer. Locking the head of transmission shaft with bolts ensures the safe operation of cutting blade, pressure plate, and screw body under high load working conditions, avoiding safety hazards caused by loose connections and safeguarding user safety. The designed connecting clamp ring and upper connecting clamp cavity ensures a stable connection between the cutting blade and the wear-resistant shaft sleeve, avoiding loosening or displacement of cutting blade during operation, ensuring the efficient cutting performance of cutting blade and the overall stability of juicer.

In further, further comprising a blocking cover, wherein the cutting blade is provided with a first bolt hole, the wear-resistant shaft sleeve is provided with a second bolt hole, the head of screw body is provided with a third bolt hole, and the bolts pass through the first bolt hole and the second bolt hole in sequence and are locked on the third bolt hole, and the blocking cover is disposed at the position of the first bolt hole and closes the first bolt hole.

The blocking cover is disposed at the position of the first bolt hole and closes the first bolt hole, effectively preventing potential safety hazards caused by bolt exposure during use, and also prevents foreign objects from entering the bolt hole, improving the equipment safety. and closes the first bolt hole to prevent debris such as fruit residue and juice from entering the bolt hole, avoiding contamination and corrosion of the bolt hole and extending the service life of the bolt and equipment. Meanwhile, the blocking cover can prevent moisture from entering bolt holes during cleaning process, reducing bolt rusting and wear, and maintaining the cleanliness and durability of the equipment. The blocking cover not only has functionality, but also makes the appearance of the equipment more neat and aesthetic. The designed blocking cover conceals the bolt and connection hole, making the juicer more concise and streamlined from the aspect of the overall appearance, improving the product's aesthetics and enhancing the user's visual experience. Bolts sequentially pass through the first bolt hole of cutting blade and the second bolt hole of the wear-resistant shaft sleeve, and lock them on the third bolt hole of screw body to form a stable connection structure. The blocking cover further protects the fastening state of the bolts, prevents loosening or displacement caused by external factors, and ensures the stability and reliability of the juicer under high load working conditions. The designed blocking cover makes it more convenient for users to clean and maintain the juicer. The closed bolt holes prevent the accumulation of dirt and fruit residue, reducing the cleaning difficulty, and allowing users to easily maintain the equipment cleanliness and hygiene.

In further, the inner cavity of screw body is a hollow inner cavity, and the hollow inner cavity forms the juice collection chamber.

The hollow inner cavity designed in the screw body forms a juice collection chamber, allowing juice to directly enter the juice collection chamber during the squeezing process. Compared to traditional designs, this internal channel design reduces the path and resistance of juice flow, improving the efficiency of juice collection. The hollow inner cavity designed allows juice to collect in the inner cavity of screw body and enter the juice collection chamber through the juice inlet. These small juice inlets which support residue separation can effectively filter fruit residue to provide purer juice and avoid the mixing of juice and residue in traditional juicers, improving the juice quality. Designing a juice collection chamber in the hollow inner cavity of screw body helps simply the overall structural design of the juicer, reducing the use of external pipelines and components. This integrated design reduces manufacturing and maintenance costs and improves equipment reliability. The integrated design of the hollow inner cavity and juice collection cavity makes juice collection more centralized and convenient. When cleaning the juicer, users only need to clean the inner cavity and juice inlet of screw body, reducing the difficulty and time of cleaning and improving the convenience of use. The designed hollow inner cavity not only reduces the weight of screw body, but also reduces the inertia force of the equipment during high-speed operation, making the juicer run more smoothly, reducing vibration and noise, and improving equipment stability and user experience.

In further, a juice outlet is provided at a position on the bottom of screw body corresponding to the juice collection chamber.

The juice outlet designed at the bottom of screw body directly discharges juice from juice collection chamber to significantly shorten the juice squeezing-discharging path and time and improve the efficiency of juice discharge, ensuring the quick juice collection and preventing juice oxidation caused by prolonged juice extraction. The juice outlet designed at the bottom of screw body makes juice discharge more direct and thorough, reduces the residue and accumulation of juice inside the equipment, making it easy for users to clean and maintain, and improving the convenience of use. The design of bottom juice outlet enables smooth discharge of juice, reducing the risk of juice accumulation and blockage in the screw body cavity, ensuring long-term stable juicer operation, and reducing the failure rate.

In further, the juice inlet is a vertical or diagonal opening.

In further, the inner wall of screw body is provided with a V-shaped groove, the tip of the V-shaped groove communicates with the juice inlet, and the opening of the V-shaped groove faces and communicates with the juice collection chamber.

The opening of V-shaped groove on the inner wall of screw body faces and communicates with the juice collection chamber, enabling the smooth flow of juice to the juice collection chamber. The combination of juice inlet designed with a vertical or diagonal opening and V-shaped groove enables the quick extraction of juice and the entry to the juice collection chamber. This precise ingredient guidance and separation design improves the extraction efficiency and juice yield, ensuring higher juice production. The vertical or diagonal opening of juice inlet and the design of V-shaped groove simplify the cleaning process. The fruit residue which is mainly left in the V-shaped groove can be more easily removed during cleaning, reducing the difficulty and time of cleaning, and improving the convenience of use.

In further, the width of juice inlet is smaller than that of the opening of the V-shaped groove.

Because of the smaller width of juice inlet than the opening width of V-shaped groove, fruit residue cannot enter the juice collection chamber, effectively reducing the impact of fruit residue on juice quality and improving the taste and clarity of juice.

The third objective of the present invention is to provide an efficient, convenient, and durable juicer.

The third objective of the present invention is realized as follows:

A juicer, comprising a main unit with a built-in power device, a juicing assembly, a feeding bin, and a juicing cylinder, wherein the juicing assembly comprises a screw body, the outer wall of screw body is provided with threads, the inner cavity of screw body is provided with a juice collection chamber, and a plurality of juice inlets communicating with the juice collection chamber are spaced on the outer wall of screw body.

The juicing cylinder is provided with a juicing chamber for accommodating juicing assembly, the juicing assembly is disposed inside the juicing chamber, and a squeezing area is formed between the outer wall of screw body and the inner wall of juicing chamber; the juicing cylinder is provided with a residue outlet communicating with the squeezing area; the juicing cylinder is disposed at a juice discharging port that communicates with the juice outlet.

The juicing cylinder is disposed on the main unit, the power component of power device runs through the juicing cylinder and connects to the screw body, and the power device drives the screw body to rotate; the feeding bin is disposed on the juicing cylinder and located above the screw body, and communicates with the juicing chamber.

The main unit, juicing assembly, feeding bin, and juicing cylinder are all designed to be detachable, so that users can easily remove and clean each component, effectively avoiding residue and improving the juicer hygiene and user experience.

During juice extraction, the power device drives the screw body to rotate, allowing the complete squeezing of fruits and vegetables in the squeezing area, thereby increasing the juice yield, and the threads designed on the outer wall of screw body also help to enhance the squeezing effect, ensuring the continuity and stability of juice extraction. Therefore, the screw body has a squeezing function.

During juice extraction, the juice enters the juice collection chamber inside the screw body through the juice inlet on the outer wall of screw body. These small juice inlets which support residue separation can effectively filter fruit residue to provide purer juice and avoid the mixing of juice and residue in traditional juicers, improving the juice quality. Therefore, the screw body has a filtering function.

The use of juice collection chamber inside the screw body for direct collection and filtering of juice simplifies the structural design of the juicer (without the need for additional filters), reducing the complex process of separating the juice and fruit residue that fall onto the bottom of juicing chamber, minimizing the number of parts that need to be cleaned in the juicer, and making cleaning simpler and more efficient. he optimized screw body design eliminates the need for additional filters in the juicer, and the integrated design of screw body facilitates user cleaning and installation.

The third objective of the present invention can also be addressed by the following technical measures:

In further, an installation chamber is provided at a position on the main unit corresponding to the juicing cylinder, the side wall of main unit is provided with a first gap and a second gap that communicate with the installation chamber, the juicing cylinder is disposed in the installation chamber, and the residue outlet is disposed in the first gap, and the juice discharging port is disposed in the second gap.

An installation chamber is provided at a position on the main unit corresponding to the juicer, and a first gap and a second gap are opened on the side wall of the main unit, so that the juicer can be accurately positioned and stably installed. The residue outlet and juice discharging port of juicer are disposed in the first gap and second gap, respectively, enabling quick installation and disassembly, and users can complete assembly and cleaning without complex operations. Optimizing juice installation has reduced the time and steps in the installation process, and improved the efficiency of the juicer. Users can assemble and disassemble more quickly, especially in situations where frequent cleaning is required, greatly improving the convenience of use. The residue outlet disposed in the first gap and the juice outlet disposed in the second gap help keep the juicing cylinder stable in the installation chamber and avoid possible loosening or displacement during the juicing process. The stable installation structure ensures the stability and safety of juicer under high load working conditions. Users can easily insert or remove juicer into or from the installation chamber, saving time and reducing operational difficulty, especially suitable for daily use needs of home and business users. The convenient operation enhances the overall user experience and satisfaction.

In further, the inner wall of feeding bin is provided with at least one convex rib for preventing the rotation of and crushing the food in the feeding bin.

The convex ribs on the inner wall of feeding bin can effectively prevent food from rotating in the feeding bin, keeping the food in a stable position when pressed by the screw body, avoiding the decrease in juicing efficiency caused by food rotation. Stable food position ensures that the food can be fully pressed, increasing the juice yield. Convex ribs not only prevent food rotation, but also provide initial crushing during the feeding process. The partial crushing of food before the food enters screw body helps the screw to press food more efficiently, further improving the juice output and quality. Convex ribs effectively avoid the situation where food gets stuck due to rotation in the feeding bin, reduces the occurrence of jamming, ensures the stability and continuity of juicer under high load working conditions, and extends the service life of the equipment. Convex ribs enable even food distribution in the feeding bin, avoiding the concentrated accumulation of food in a certain position, so that the screw can apply pressure evenly, ensuring the uniform juicing effect and improving the juice quality.

In further, slots are provided at interval at the open position of juicing cylinder in the juicing chamber, blocks are provided at interval at the lower port of the feeding bin, and those blocks are inserted into the slots to tightly clamp the feeding bin and juicing cylinder together.

Slots are provided at interval at the open position of juicing cylinder in the juicing chamber, blocks are provided at interval at the lower port of the feeding bin, and those blocks are inserted into the slots to tightly clamp the feeding bin and juicing cylinder together. This design enables the feeding bin and juicer to be firmly fixed together, avoiding looseness and shaking during operation, and improving the stability and safety of the equipment. The designed slots and blocks make it easy to assemble and disassemble the feeding bin and juicer. Users only need to insert blocks into slots to complete the assembly, without the need for additional tools or complex steps, which improves the usability and operational efficiency of the equipment. The tight slot-block connection ensure the stability of feeding bin and juicer, reducing the instability that may occur during the juicing process due to movement or shaking. Users can operate the juicer with more peace of mind and safety during use.

In further, the juicing assembly comprising a pressure plate, a cutting blade, and a transmission shaft, wherein the transmission shaft disposed in the inner cavity of screw body is integrally formed with the screw body, and the head of transmission shaft runs through the screw body and extends outward;

the cutting blade is rotatably disposed on the pressure plate, and the pressure plate is connected to the screw body and located above the screw body; the head of transmission shaft runs through the pressure plate and is connected to the cutting blade, and the rotating transmission shaft enables the synchronous rotation of screw body and cutting blade.

The cutting blade rotates synchronously with the screw body to initially cut the food entering the screw body, which can effectively chop large pieces of food, reduce the workload of screw body, and improve the efficiency of the entire pressing process.

The pressure plate disposed above the screw body prevents the screw from moving upwards during juice extraction, thereby fixing the screw position and ensuring the stability of food during squeezing process, improving the juice yield and juice quality.

Since the pressure plate disposed above the screw body prevents the screw from moving upwards during juice extraction, fixing the screw position, the power device drives the screw body and cutting blade to rotate synchronously through the power components and transmission shaft, so that the food can be fully cut and crushed before entering the screw body, reducing machine jamming, and improving the stability and continuity of the juicer.

The integrated design of screw body, cutting blade, and pressure plate allows users to easily disassemble and clean the entire juicing assembly after use, reducing the cleaning difficulties caused by the separation of multiple components in traditional juicers. In further, the assembly process is also simpler, and users can complete equipment assembly and disassembly without tedious operations, improving the convenience of use.

The integrated design reduces the connection and wear between assemblies, reduces the risk of equipment failure caused by loose or damaged components, enhances the overall safety and durability of the juicer, and extends the service life of equipment. Placing transmission shaft inside the screw body cavity and integrating the transmission shaft and screw body simplify the internal structural design of juicer, reduce the number and complexity of parts, thereby reducing manufacturing and maintenance costs.

The integrated design and optimized synchronous rotation mechanism make the juicer run more smoothly during operation, reduce mechanical noise, provide a quieter usage environment, and enhance the user experience.

In further, the juicing assembly, further comprising a bolt and a wear-resistant sleeve, wherein the inner cavity of wear-resistant sleeve is provided with a connecting cavity that fits the shape of the head of transmission shaft;

the pressure plate is provided with a socket, the wear-resistant shaft sleeve is disposed inside the socket, the upper end of the wear-resistant shaft sleeve is provided with an upper connecting clamp ring, the bottom of the cutting blade is provided with an upper connecting clamp cavity that fits the shape of the upper connecting clamp ring, the upper connecting clamp ring is inserted into the upper connecting clamp cavity, and the bolt runs through the cutting blade to lock the wear-resistant shaft sleeve, so as to connect the wear-resistant shaft sleeve with the cutting blade; the head of transmission shaft is inserted into the connecting cavity, and the bolt locks the head of transmission shaft to connect the cutting blade, pressure plate, and screw body together. The wear-resistant shaft sleeve inside the socket has excellent wear resistance and can effectively reduce the friction and wear between the transmission shaft and the pressure plate, prolong the service life of the juicer, and improve the reliability of the equipment. The head of transmission shaft tightly fits with the wear-resistant shaft sleeve through the connecting cavity, and the bolt passes through the cutting blade and locks the wear-resistant shaft sleeve, ensuring a stable connection between the cutting blade, the pressure plate, and the screw body. The stable connection structure avoids the loosening and displacement of components during operation, improving the stability and safety of the juicer. The designed upper connecting clamp ring and upper connecting clamp cavity enables the quick installation of cutting blade on the wear-resistant shaft sleeve, and the head of transmission shaft is locked with bolts to realize rapid assembly and disassembly. The stable connection and wear-resistant design ensure that the cutting blade can effectively perform preliminary cutting treatment on the food during rotation, improve the pressing efficiency of the food entering the screw body, and ensure efficient juice yield. The application of wear-resistant parts reduces the wear between the transmission shaft and other components, lowers the jamming and equipment failure rate caused by wear, and improves the overall performance and user experience of the juicer. Locking the head of transmission shaft with bolts ensures the safe operation of cutting blade, pressure plate, and screw body under high load working conditions, avoiding safety hazards caused by loose connections and safeguarding user safety. The designed connecting clamp ring and upper connecting clamp cavity ensures a stable connection between the cutting blade and the wear-resistant shaft sleeve, avoiding loosening or displacement of cutting blade during operation, ensuring the efficient cutting performance of cutting blade and the overall stability of juicer.

In further, further comprising a blocking cover, wherein the cutting blade is provided with a first bolt hole, the wear-resistant shaft sleeve is provided with a second bolt hole, the head of screw body is provided with a third bolt hole, and the bolts pass through the first bolt hole and the second bolt hole in sequence and are locked on the third bolt hole, and the blocking cover is disposed at the position of the first bolt hole and closes the first bolt hole.

The blocking cover is disposed at the position of the first bolt hole and closes the first bolt hole, effectively preventing potential safety hazards caused by bolt exposure during use, and also prevents foreign objects from entering the bolt hole, improving the equipment safety.

The blocking cover closes the first bolt hole to prevent debris such as fruit residue and juice from entering the bolt hole, avoiding contamination and corrosion of the bolt hole and extending the service life of the bolt and equipment. Meanwhile, the blocking cover can prevent moisture from entering bolt holes during cleaning process, reducing bolt rusting and wear, and maintaining the cleanliness and durability of the equipment. The blocking cover not only has functionality, but also makes the appearance of the equipment more neat and aesthetic. The designed blocking cover conceals the bolt and connection hole, making the juicer more concise and streamlined from the aspect of the overall appearance, improving the product's aesthetics and enhancing the user's visual experience. Bolts sequentially pass through the first bolt hole of cutting blade and the second bolt hole of the wear-resistant shaft sleeve, and lock them on the third bolt hole of screw body to form a stable connection structure. The blocking cover further protects the fastening state of the bolts, prevents loosening or displacement caused by external factors, and ensures the stability and reliability of the juicer under high load working conditions. The designed blocking cover makes it more convenient for users to clean and maintain the juicer. The closed bolt holes prevent the accumulation of dirt and fruit residue, reducing the cleaning difficulty, and allowing users to easily maintain the equipment cleanliness and hygiene.

In further, the inner cavity of screw body is a hollow inner cavity, and the hollow inner cavity forms the juice collection chamber.

The hollow inner cavity designed in the screw body forms a juice collection chamber, allowing juice to directly enter the juice collection chamber during the squeezing process. Compared to traditional designs, this internal channel design reduces the path and resistance of juice flow, improving the efficiency of juice collection. The hollow inner cavity designed allows juice to collect in the inner cavity of screw body and enter the juice collection chamber through the juice inlet. These small juice inlets which support residue separation can effectively filter fruit residue to provide purer juice and avoid the mixing of juice and residue in traditional juicers, improving the juice quality. Designing a juice collection chamber in the hollow inner cavity of screw body helps simply the overall structural design of the juicer, reducing the use of external pipelines and components. This integrated design reduces manufacturing and maintenance costs and improves equipment reliability. The integrated design of the hollow inner cavity and juice collection cavity makes juice collection more centralized and convenient. When cleaning the juicer, users only need to clean the inner cavity and juice inlet of screw body, reducing the difficulty and time of cleaning and improving the convenience of use. The designed hollow inner cavity not only reduces the weight of screw body, but also reduces the inertia force of the equipment during high-speed operation, making the juicer run more smoothly, reducing vibration and noise, and improving equipment stability and user experience.

In further, a juice outlet is provided at a position on the bottom of screw body corresponding to the juice collection chamber.

The juice outlet designed at the bottom of screw body directly discharges juice from juice collection chamber to significantly shorten the juice squeezing-discharging path and time and improve the efficiency of juice discharge, ensuring the quick juice collection and preventing juice oxidation caused by prolonged juice extraction. The juice outlet designed at the bottom of screw body makes juice discharge more direct and thorough, reduces the residue and accumulation of juice inside the equipment, making it easy for users to clean and maintain, and improving the convenience of use. The design of bottom juice outlet enables smooth discharge of juice, reducing the risk of juice accumulation and blockage in the screw body cavity, ensuring long-term stable juicer operation, and reducing the failure rate.

In further, the juice inlet is a vertical opening, the inner wall of screw body is provided with a V-shaped groove, the tip of the V-shaped groove communicates with the juice inlet, and the opening of the V-shaped groove faces and communicates with the juice collection chamber, and the width of juice inlet is smaller than that of the opening of the V-shaped groove.

The opening of V-shaped groove on the inner wall of screw body faces and communicates with the juice collection chamber, enabling the smooth flow of juice to the juice collection chamber. Because of the smaller width of juice inlet than the opening width of V-shaped groove, fruit residue cannot enter the juice collection chamber, effectively reducing the impact of fruit residue on juice quality and improving the taste and clarity of juice. The combination of juice inlet designed with a vertical or diagonal opening and V-shaped groove enables the quick extraction of juice and the entry to the juice collection chamber. This precise ingredient guidance and separation design improves the extraction efficiency and juice yield, ensuring higher juice production.

The vertical or diagonal opening of juice inlet and the design of V-shaped groove simplify the cleaning process. The fruit residue which is mainly left in the V-shaped groove can be more easily removed during cleaning, reducing the difficulty and time of cleaning, and improving the convenience of use.

The present invention has the following beneficial effects:
(1) During juice extraction of the present invention, the juice enters the juice collection chamber inside the screw body through the juice inlet on the outer wall of screw body. These small juice inlets which support residue separation can effectively filter fruit residue to provide purer juice and avoid the mixing of juice and residue in traditional juicers, improving the juice quality. In the present invention, the use of juice collection chamber inside the screw body for direct collection and filtering of juice simplifies the structural design of the juicer, reducing the complex process of separating the juice and fruit residue that fall onto the bottom of juicing chamber, minimizing the number of parts that need to be cleaned in the juicer, and making cleaning simpler and more efficient. In the present invention, the juice outlet designed at the bottom of screw body directly discharges juice from juice collection chamber to significantly shorten the juice squeezing-discharging path and time and improve the efficiency of juice discharge, ensuring the quick juice collection. In the present invention, the vertical or diagonal opening of juice inlet and the design of V-shaped groove simplify the cleaning process. The fruit residue which is mainly left in the V-shaped groove can be more easily removed during cleaning, reducing the difficulty and time of cleaning, and improving the convenience of use. In the present invention, because of the smaller width of juice inlet than the opening width of V-shaped groove, fruit residue cannot enter the juice collection chamber, effectively reducing the impact of fruit residue on juice quality and improving the taste and clarity of juice.
(2) In the present invention, the cutting blade rotates synchronously with the screw body to initially cut the food entering the screw body, which can effectively chop large pieces of food, reduce the workload of screw body, and improve the efficiency of the entire pressing process. In the present invention, the pressure plate disposed above the screw body prevents the screw from moving upwards during juice extraction, thereby fixing the screw position and ensuring the stability of food during squeezing process, improving the juice yield and juice quality. In the present invention, the motor drives the screw body and cutting blade to rotate synchronously through the rotating shaft and transmission shaft, so that the food can be fully cut and crushed before entering the screw body, reducing machine jamming, and improving the stability and continuity of the juicer. In the present invention, the integrated design of screw body, cutting blade, and pressure plate allows users to easily disassemble and clean the entire juicing assembly after use, reducing the cleaning difficulties caused by the separation of multiple components in traditional juicers. In further, the assembly process is also simpler, and users can complete equipment assembly and disassembly without tedious operations, improving the convenience of use. In the present invention, placing transmission shaft inside the screw body cavity and integrating the transmission shaft and screw body simplify the internal structural design of juicer, reduce the number and complexity of parts, thereby reducing manufacturing and maintenance costs. In the present invention, the integrated design and optimized synchronous rotation mechanism make the juicer run more smoothly during operation, reduce mechanical noise, provide a quieter usage environment, and enhance the user experience.

In the present invention, the main unit, juicing assembly, feeding bin, and juicing cylinder are all designed to be detachable, so that users can easily remove and clean each component, effectively avoiding residue and improving the juicer hygiene and user experience. In the present invention, during juice extraction, the juice enters the juice collection chamber inside the screw body through the juice inlet on the outer wall of screw body. These small juice inlets which support residue separation can effectively filter fruit residue to provide purer juice and avoid the mixing of juice and residue in traditional juicers, improving the juice quality. In the present invention, the use of juice collection chamber inside the screw body for direct collection and filtering of juice simplifies the structural design of the juicer, reducing the complex process of separating the juice and fruit residue that fall onto the bottom of juicing chamber, lowering the failure rate and maintenance costs of the machine. In the present invention, the power device drives the screw body to rotate, allowing the complete squeezing of fruits and vegetables in the squeezing area, thereby increasing the juice yield. The threads designed on the outer wall of screw body also help to enhance the squeezing effect, ensuring the continuity and stability of juice extraction.In the present invention, an installation chamber is provided at a position on the main unit corresponding to the juicer, and a first gap and a second gap are opened on the side wall of the main unit, so that the juicer can be accurately positioned and stably installed. The residue outlet and juice discharging port of juicer are disposed in the first gap and second gap, respectively, enabling quick installation and disassembly, and users can complete assembly and cleaning without complex operations. In the present invention, the convex ribs on the inner wall of feeding bin can effectively prevent food from rotating in the feeding bin, keeping the food in a stable position when pressed by the screw body, avoiding the decrease in juicing efficiency caused by food rotation. Stable food position ensures that the food can be fully pressed, increasing the juice yield. Convex ribs not only prevent food rotation, but also provide initial crushing during the feeding process. The partial crushing of food before the food enters screw body helps the screw to press food more efficiently, further improving the juice output and quality. In the present invention, the designed slots and blocks make it easy to assemble and disassemble the feeding bin and juicer. Users only need to insert blocks into slots to complete the assembly, without the need for additional tools or complex steps, which improves the usability and operational efficiency of the equipment. In the present invention, the cutting blade rotates synchronously with the screw body to initially cut the food entering the screw body, which can effectively chop large pieces of food, reduce the workload of screw body, and improve the efficiency of the entire pressing process. In the present invention, the pressure plate disposed above the screw body prevents the screw from moving upwards during juice extraction, thereby fixing the screw position and ensuring the stability of food during squeezing process, improving the juice yield and juice quality. In the present invention, the integrated design of screw body, cutting blade, and pressure plate allows users to easily disassemble and clean the entire juicing assembly after use, reducing the cleaning difficulties caused by the separation of multiple components in traditional juicers. In further, the assembly process is also simpler, and users can complete equipment assembly and disassembly without tedious operations, improving the convenience of use.

### BRIEF DESCRIPTION OF THE DRAWINGS

FIG. 1 is a schematic diagram of a juicer.

FIG. 2 is a schematic diagram of the juicer from another angle.

FIG. 3 is a sectional view of the juicer.

FIG. 4 is a schematic diagram of the assembly of the feeding bin and juicer.

FIG. 5 is a schematic diagram of the assembly of the feeding bin, juicer, and main unit.

FIG. 6 is a schematic diagram of the assembly of the feeding bin, juicer, juicer assembly, and main unit.

FIG. 7 is a schematic diagram of the juicer.

FIG. 8 is a schematic diagram of the juicing assembly.

FIG. 9 is a schematic diagram of the juicing assembly from another angle.

FIG. 10 is a sectional view of the juicing assembly.

FIG. 11 is a schematic diagram of the assembly of the screw body and cutting blade.

FIG. 12 is a schematic diagram of the assembly of the screw body and cutting blade from another angle.

FIG. 13 is an exploded view of the juicing assembly.

FIG. 14 is a schematic diagram of the screw body.

FIG. 15 is a schematic diagram of the screw body from another angle.

FIG. 16 is a sectional view of the screw body.

### DESCRIPTION OF EMBODIMENTS

The present invention will be further described below in conjunction with the accompanying drawings and embodiments.

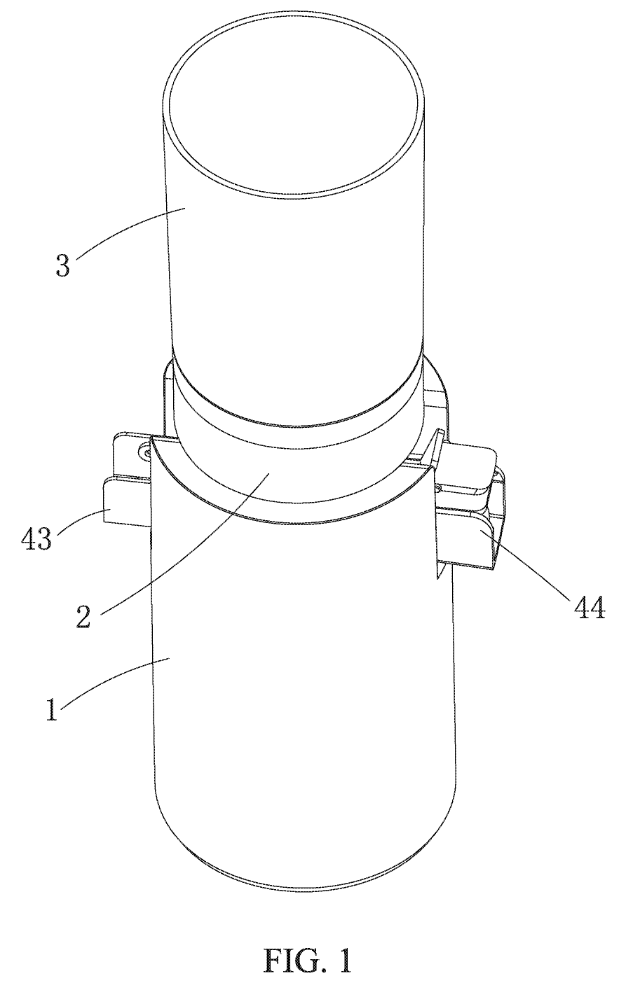

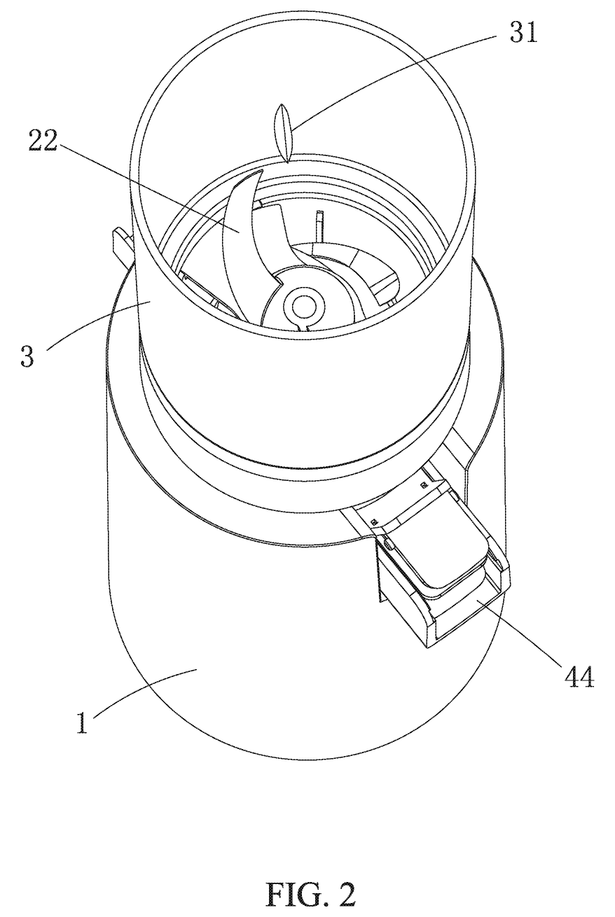

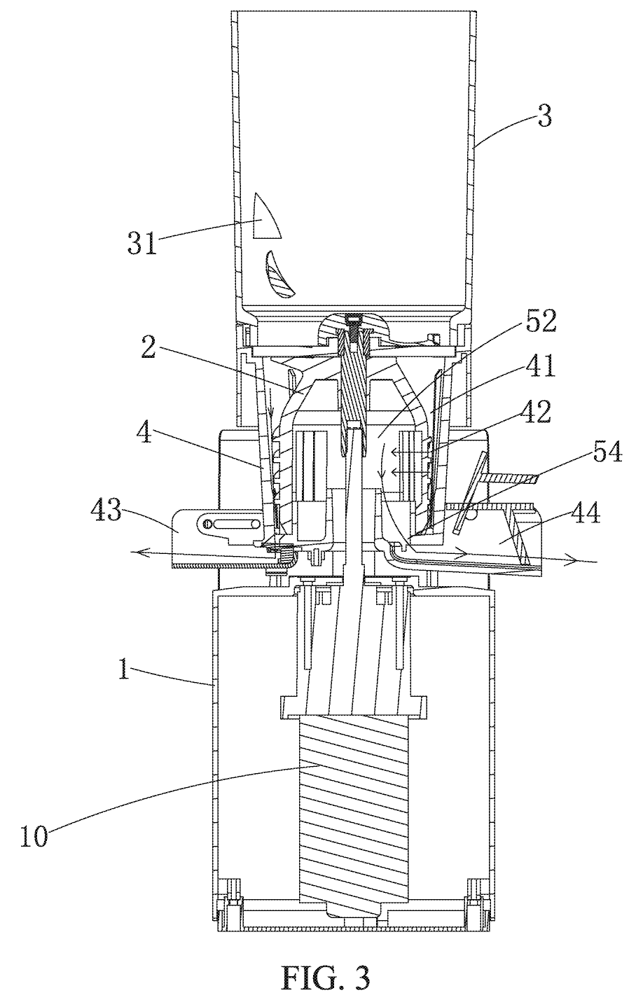

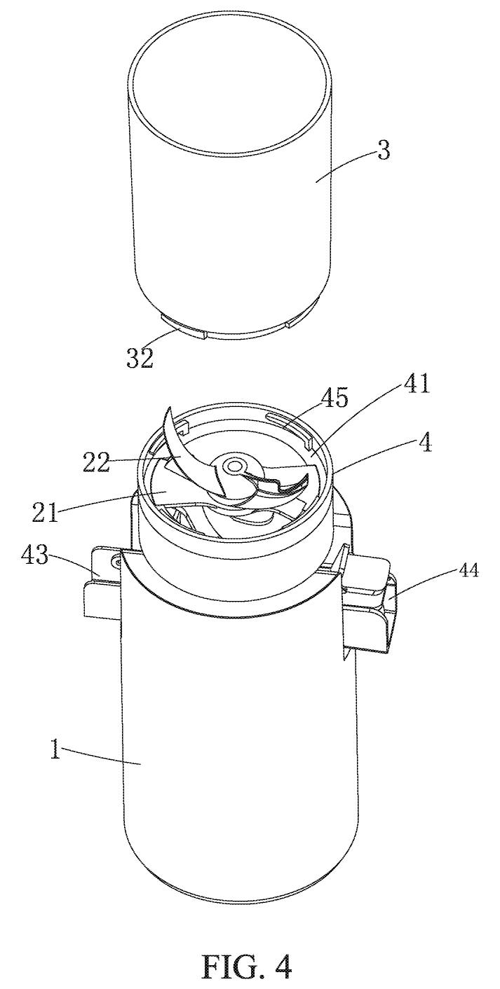

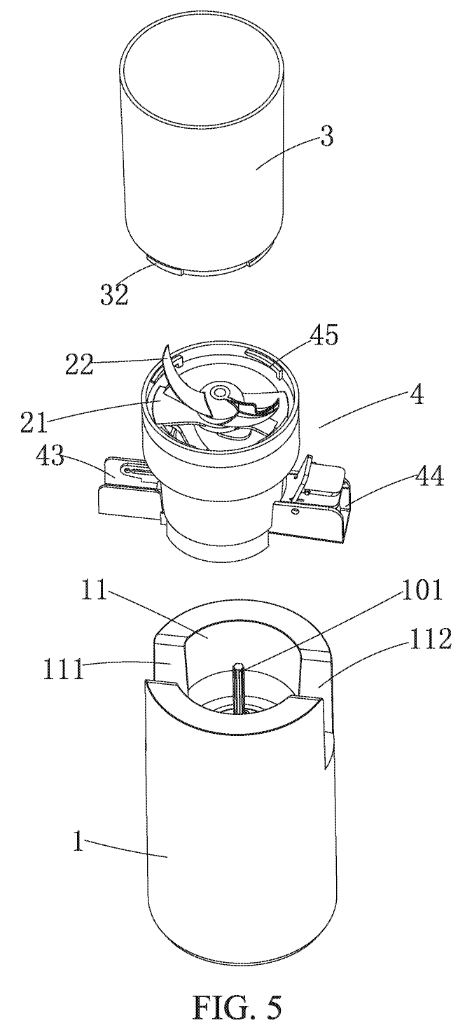

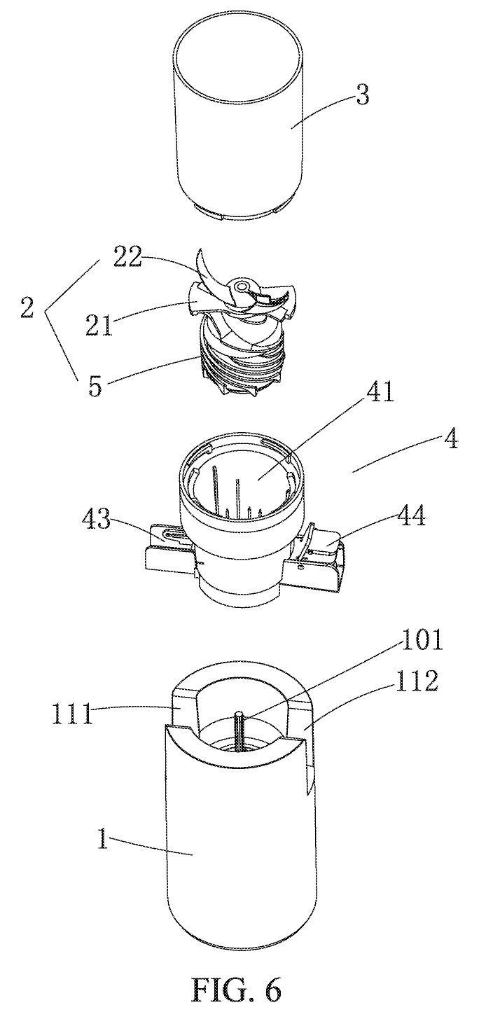

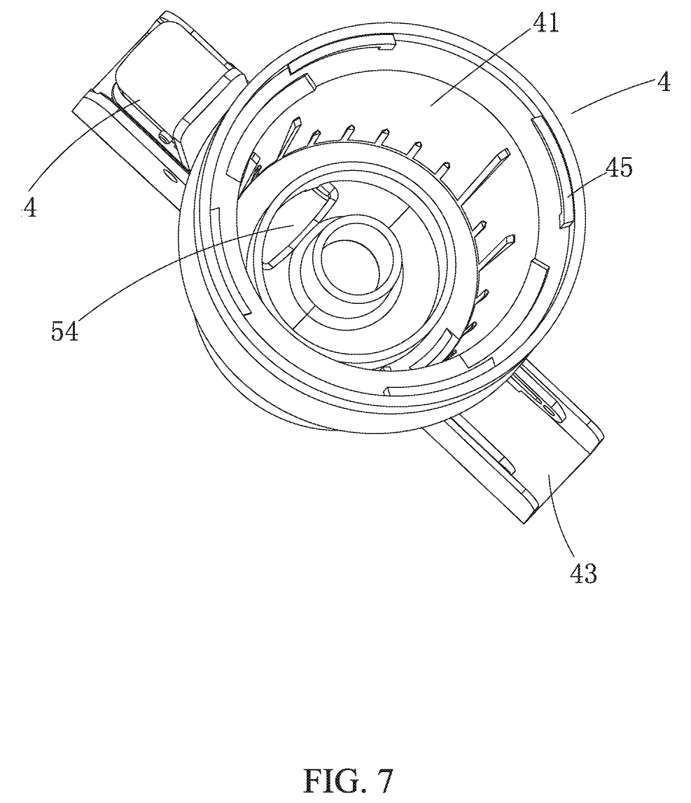

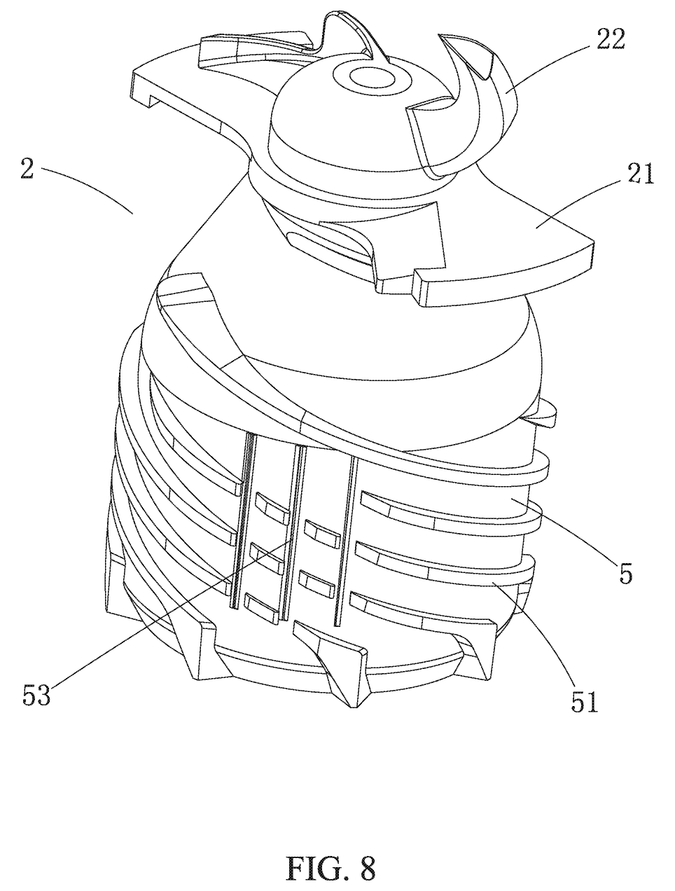

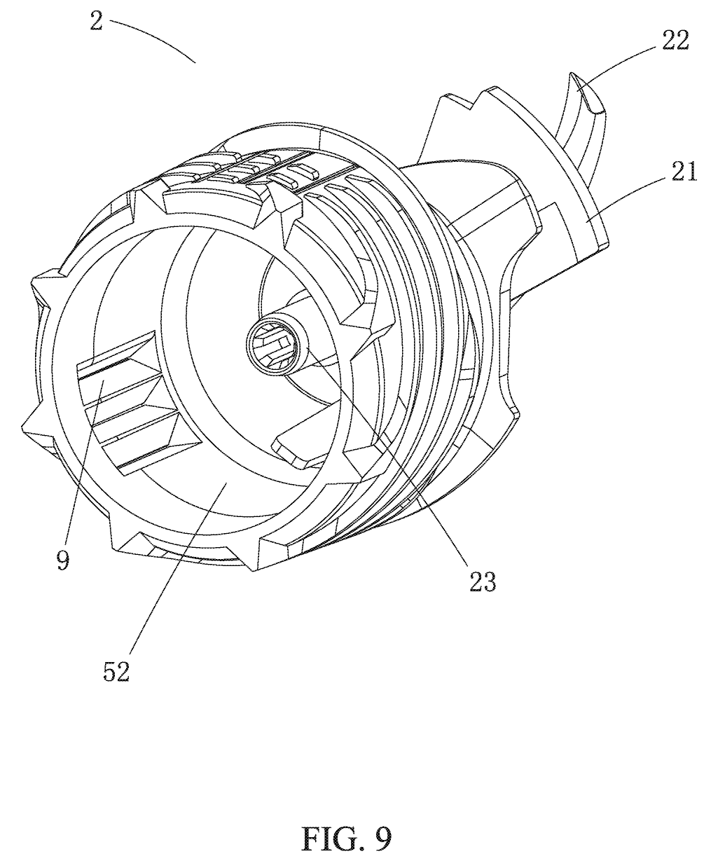

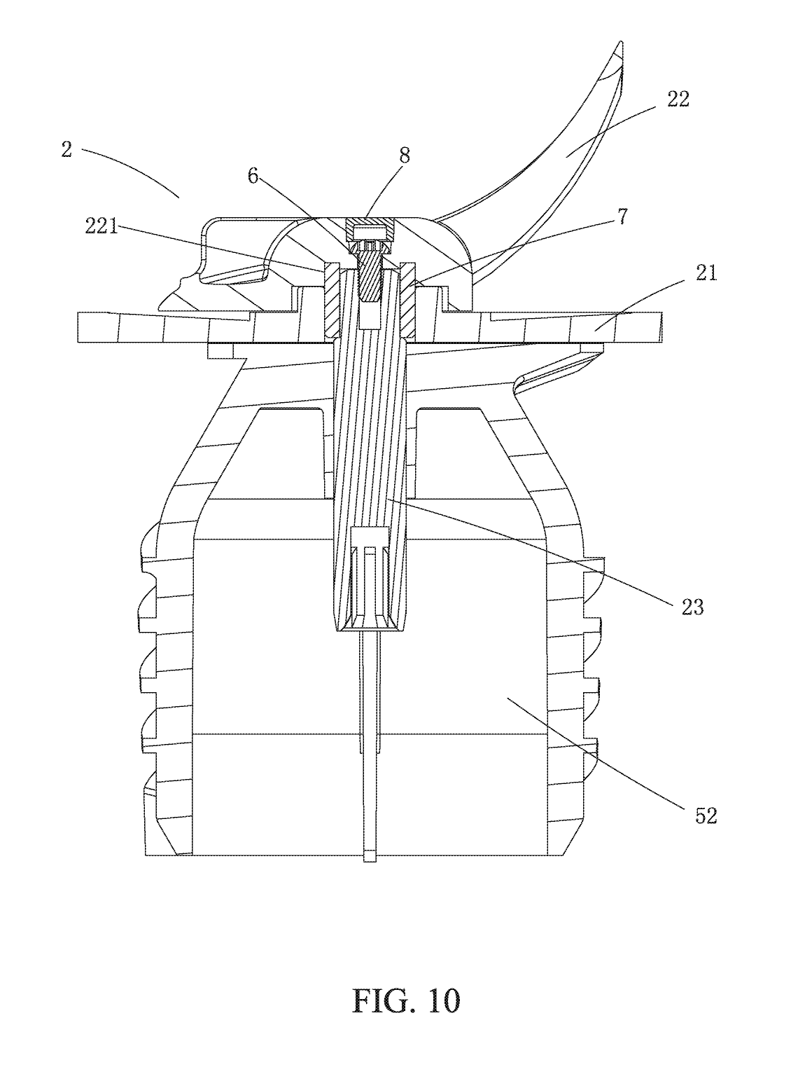

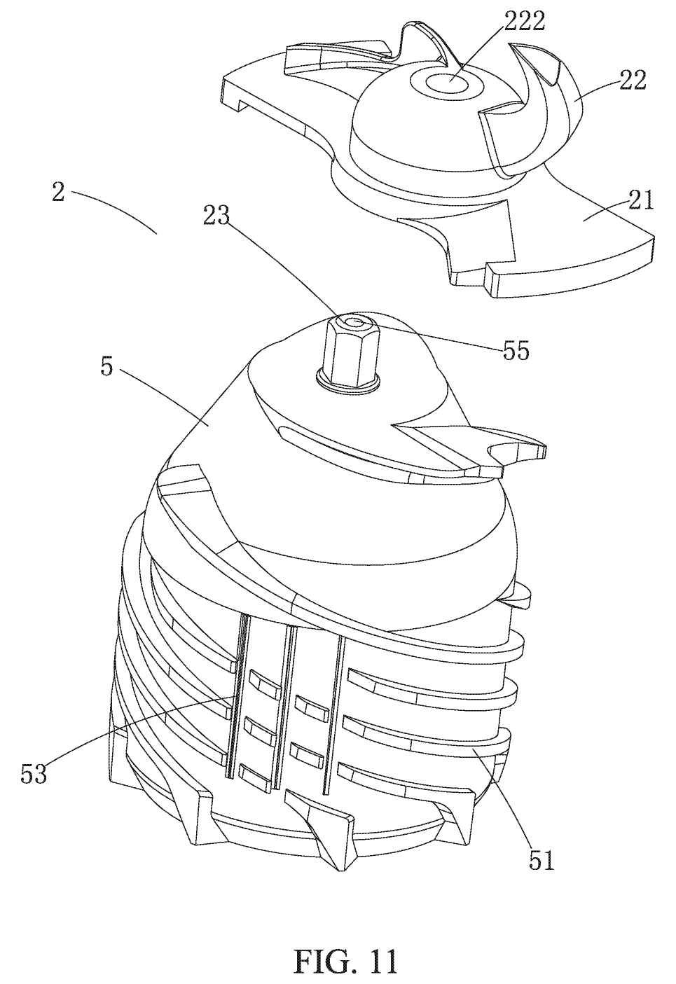

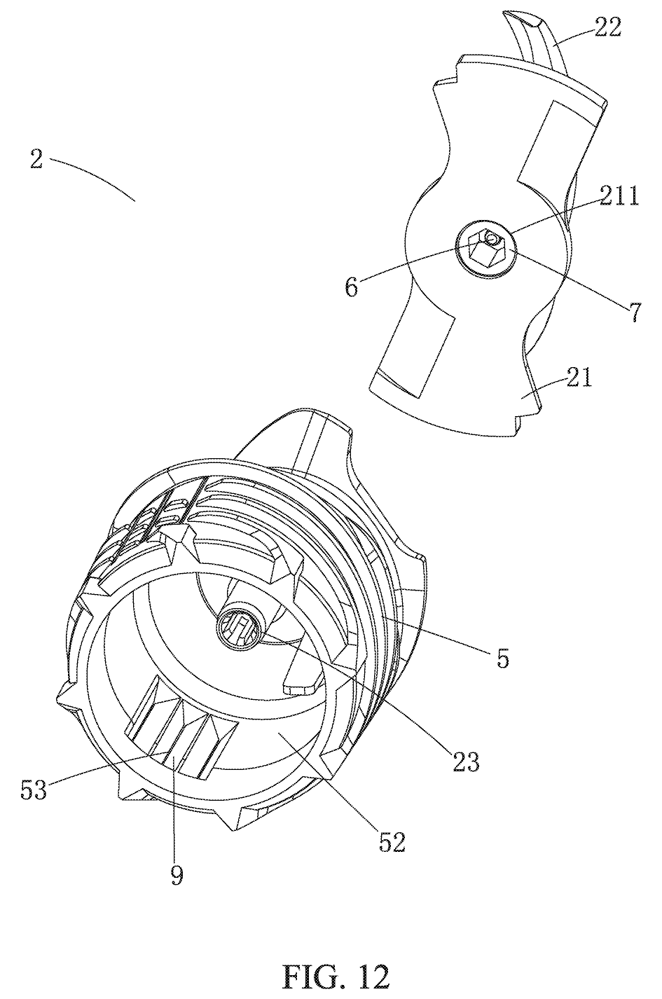

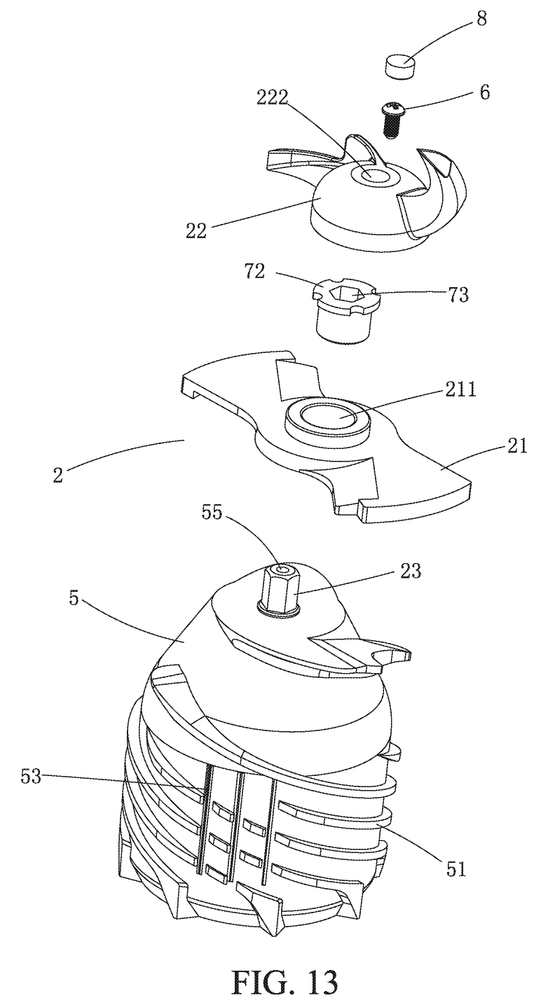

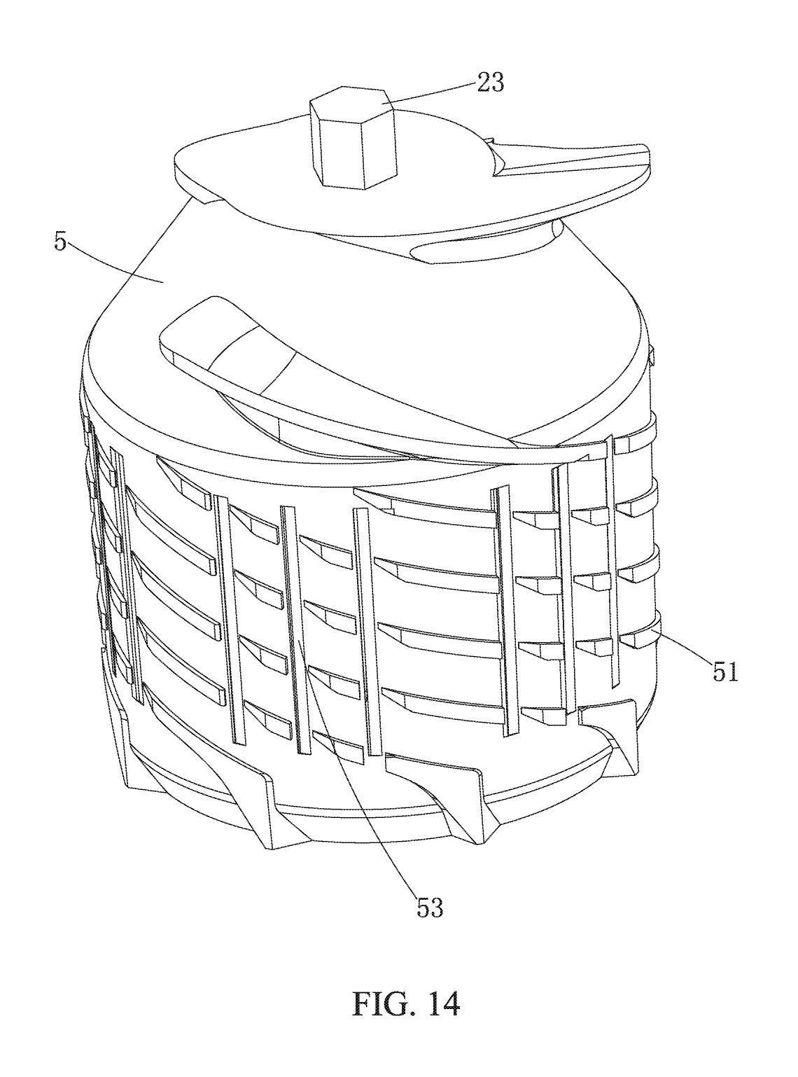

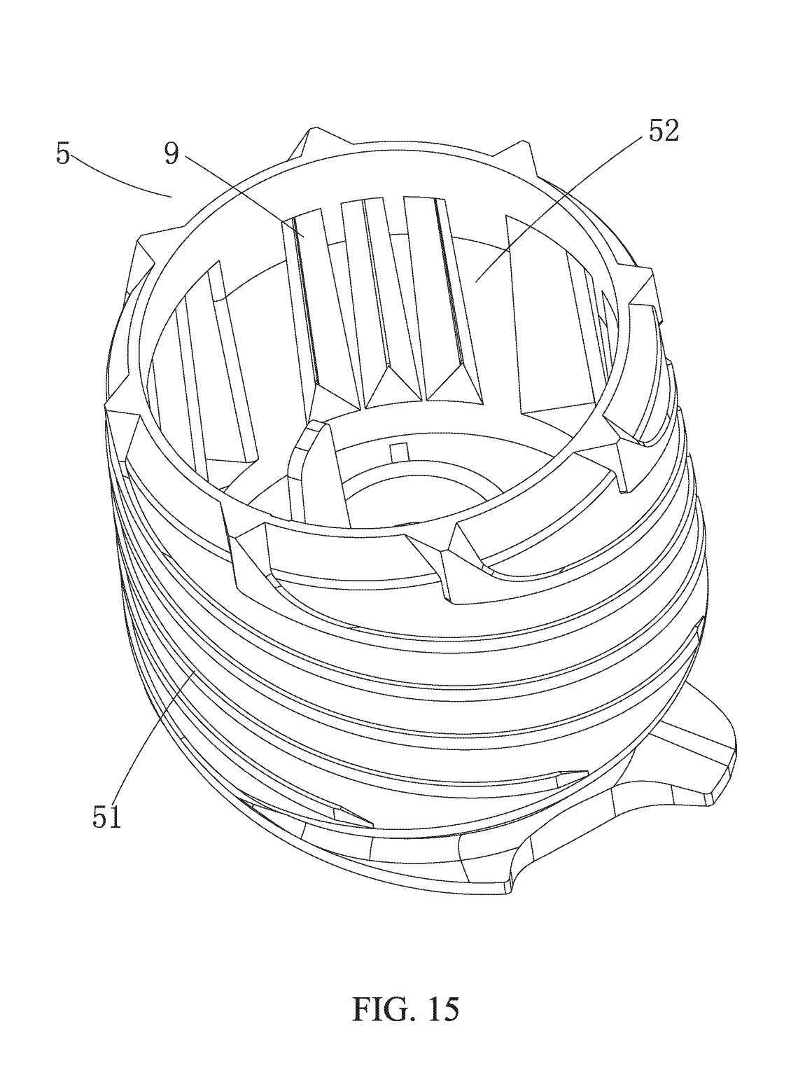

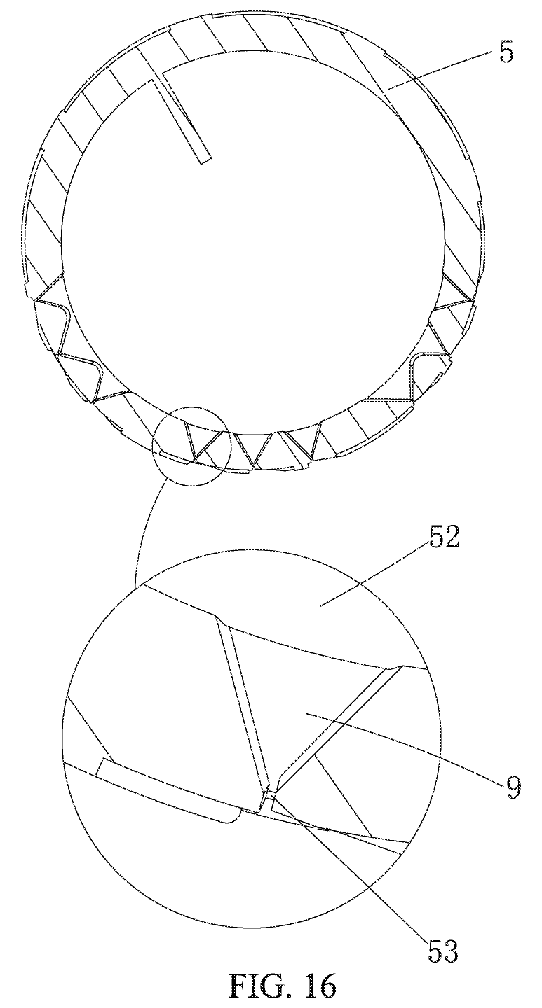

In an embodiments, as shown in FIGS. 1-16, a juicer, comprising a main unit 1 with a built-in power device, a juicing assembly 2, a feeding bin 3, and a juicing cylinder 4, the juicing assembly 2 comprises a screw body 5, and the outer wall of screw body 5 is provided with threads 51, the inner cavity of screw body 5 is provided with a juice collection chamber 52, and a plurality of juice inlets 53 communicating with the juice collection chamber 52 are spaced on the outer wall of screw body 5. The juicing cylinder 4 is provided with a juicing chamber 41 for accommodating juicing assembly 2, the juicing assembly 2 is disposed inside the juicing chamber 41, and a squeezing area 42 is formed between the outer wall of screw body 5 and the inner wall of juicing chamber 41; the juicing cylinder 4 is provided with a residue outlet 43 communicating with the squeezing area 42; the juicing cylinder 4 is disposed at a juice discharging port 44 that communicates with the juice outlet 54. The juicing cylinder 4 is disposed on the main unit 1, the power device comprises a motor 10 and a reducer, the input end of the reducer is connected to the shaft of the motor 10, and the output end 101 of the reducer passes through the juicing cylinder 4 and is connected to the screw body 5, and the power device drives the screw body 5 to rotate; the feeding bin 3 is disposed on the juicing cylinder 4 and located above the screw body 5, and communicates with the juicing chamber 41.

In further, an installation chamber 11 is provided at a position on the main unit 1 corresponding to the juicing cylinder 4, the side wall of main unit 1 is provided with a first gap 111 and a second gap 112 that communicate with the installation chamber 11, the juicing cylinder 4 is disposed in the installation chamber 11, and the residue outlet 43 is disposed in the first gap 111, and the juice outlet 44 is disposed in the second gap 112.

In further, the inner wall of feeding bin 3 is provided with at least one convex rib 31 for preventing the rotation of and crushing the food in the feeding bin 3.

In further, slots 45 are provided at interval at the open position of juicing cylinder 4 in the juicing chamber 41, blocks 32 are provided at interval at the lower port of the feeding bin 3, and those blocks 32 are inserted into the slots 45 to tightly clamp the feeding bin 3 and juicing cylinder 4 together.

In further, the juicing assembly 2 further comprising a pressure plate 21, a cutting blade 22, and a transmission shaft 23, wherein the transmission shaft 23 disposed in the inner cavity of screw body 5 is integrally formed with the screw body 5, and the head of transmission shaft 23 runs through the screw body 5 and extends outward; the cutting blade 22 is rotatably disposed on the pressure plate 21, and the pressure plate 21 is connected to the screw body 5 and located above the screw body 5; the head of transmission shaft 23 runs through the pressure plate 21 and is connected to the cutting blade 22; the output end 101 of the power device is connected to the transmission shaft 23, and power device drives the synchronous rotation of screw body 5 and cutting blade 22 through output end 101 and transmission shaft 22.

In further, further comprising a bolt 6 and a wear-resistant sleeve 7, wherein the inner cavity of wear-resistant sleeve 7 is provided with a connecting cavity 71 that fits the shape of the head of transmission shaft 23; the pressure plate 21 is provided with a socket 211, the wear-resistant shaft sleeve 7 is disposed inside the socket 211, the upper end of the wear-resistant shaft sleeve 7 is provided with an upper connecting clamp ring 72, the bottom of the cutting blade 22 is provided with an upper connecting clamp cavity 221 that fits the shape of the upper connecting clamp ring 72, the upper connecting clamp ring 72 is inserted into the upper connecting clamp cavity 221, and the bolt 6 runs through the cutting blade 22 to lock the wear-resistant shaft sleeve 7, so as to connect the wear-resistant shaft sleeve 7 with the cutting blade 22; the head of transmission shaft 23 is inserted into the connecting cavity 71, and the bolt 6 locks the head of transmission shaft 23 to connect the cutting blade 22, pressure plate 21, and screw body 5 together.

In further, further comprising a blocking cover 8, wherein the cutting blade is provided with a first bolt hole 222, the wear-resistant shaft sleeve 7 is provided with a second bolt hole 73, the head of screw body 5 is provided with a third bolt hole 55, and the bolts 6 pass through the first bolt hole 222 and the second bolt hole 73 in sequence and are locked on the third bolt hole 55, and the blocking cover 8 is disposed at the position of the first bolt hole 222 and closes the first bolt hole 222.

In further, the inner cavity of screw body 5 is a hollow inner cavity, and the hollow inner cavity forms the juice collection chamber.

In further, a juice outlet 54 is provided at a position on the bottom of screw body 5 corresponding to the juice collection chamber 52.

In further, the juice inlet 53 is a vertical opening, the inner wall of screw body 5 is provided with a V-shaped groove 9, the tip of the V-shaped groove 9 communicates with the juice inlet 53, the opening of the V-shaped groove 9 faces and communicates with the juice collection chamber 52, and the width of juice inlet 53 is smaller than that of the opening of the V-shaped groove 9.

Assembly of juicer: Users place the juicer 4 in the installation chamber 11 of the main unit 1, the residue outlet 43 in the first gap 111 and the juice discharging port 44 in the second gap 112, completing the assembly of juicer 4 and main unit 1; then place the juicing assembly 2 in the juicing chamber 41 of the juicing cylinder 4, connect the output end 101 of power device and transmission shaft 23 together, and complete the assembly of juicing assembly 2 and juicing cylinder 4; finally, place the feeding bin 3 on the juicer 4 and insert the block 32 into the slot 45, and complete the assembly of the feeding bin 3 and juicer 4.

### Juicer juicing

Loading the food: Users put the cut food into the feeding bin 3 of the juicer.

Starting the juicer: Users start the power device, and the output end 101 of power device drives the screw body 5 and cutting blade 22 in the juicing assembly 2 to start rotating.

Squeezing and crushing: Before entering the squeezing area 42 of the juicing assembly 2 from the feeding bin 3, the food is initially chopped by the cutting blade 22 and the convex rib 31, enters the squeezing area 42, and is then gradually pressed and crushed by the threads 51 of screw body 5, and the food is prevented from exiting the squeezing area 42 by the pressure plate 21.

Juice separation: During the squeezing process, the juice is squeezed out to enter the juice collection chamber 52 of screw body 5 through juice inlet 53, and is then guided by the juice collection chamber 52 to the juice outlet 54.

Juice collection: Juice flows out from juice outlet 54 and juice discharging port 44, and users can use a container to collect freshly squeezed juice.

Residue removal: After pressing, solid food residue is removed through residue outlet 43.

Stop and cleaning: After completing juice extraction, users may stop the power device, remove juicing assembly 2 and feeding bin 3 to remove food residue and clean the equipment.

What is claimed is:

1. A screw comprising a screw body, wherein:
the outer wall of screw body is provided with threads;
the inner cavity of screw body is provided with a juice collection chamber;
a plurality of juice inlets communicating with the juice collection chamber are spaced on the outer wall of screw body.

2. The screw according to claim 1, wherein the inner cavity of screw body is a hollow inner cavity, and the hollow inner cavity forms the juice collection chamber.

3. The screw according to claim 1, wherein a juice outlet is provided at a position on the bottom of screw body corresponding to the juice collection chamber.

4. The screw according to claim 1, wherein the juice inlet is a vertical or diagonal opening.

5. The screw according to claim 1, wherein the inner wall of screw body is provided with a V-shaped groove, the tip of the V-shaped groove communicates with the juice inlet, and the opening of the V-shaped groove faces and communicates with the juice collection chamber.

6. A juicing assembly comprising a screw body, a pressure plate, a cutting blade, and a transmission shaft, wherein:
the outer wall of screw body is provided with threads;
the inner cavity of screw body is provided with a juice collection chamber;
a plurality of juice inlets communicating with the juice collection chamber are spaced on the outer wall of screw body;
the transmission shaft disposed in the inner cavity of screw body is integrally formed with the screw body, and the head of transmission shaft runs through the screw body and extends outward;
the cutting blade is rotatably disposed on the pressure plate, and the pressure plate is connected to the screw body and located above the screw body;
the head of transmission shaft runs through the pressure plate and is connected to the cutting blade, and the rotating transmission shaft enables the synchronous rotation of screw body and cutting blade.

7. The juicing assembly according to claim 6, further comprising a bolt and a wear-resistant sleeve, wherein the inner cavity of wear-resistant sleeve is provided with a connecting cavity that fits the shape of the head of transmission shaft;
the pressure plate is provided with a socket, the wear-resistant shaft sleeve is disposed inside the socket, the upper end of the wear-resistant shaft sleeve is provided with an upper connecting clamp ring, the bottom of the cutting blade is provided with an upper connecting clamp cavity that fits the shape of the upper connecting clamp ring, the upper connecting clamp ring is inserted into the upper connecting clamp cavity, and the bolt runs through the cutting blade to lock the wear-resistant shaft sleeve, so as to connect the wear-resistant shaft sleeve with the cutting blade;
the head of transmission shaft is inserted into the connecting cavity, and the bolt locks the head of transmission shaft to connect the cutting blade, pressure plate, and screw body together.

8. The juicing assembly according to claim 7, further comprising a blocking cover, wherein the cutting blade is provided with a first bolt hole, the wear-resistant shaft sleeve is provided with a second bolt hole, the head of screw body is provided with a third bolt hole, and the bolts pass through the first bolt hole and the second bolt hole in sequence and are locked on the third bolt hole, and the blocking cover is disposed at the position of the first bolt hole and closes the first bolt hole.

9. The juicing assembly according to claim 6, wherein the inner cavity of screw body is a hollow inner cavity, and the hollow inner cavity forms the juice collection chamber.

10. The juicing assembly according to claim 6, wherein a juice outlet is provided at a position on the bottom of screw body corresponding to the juice collection chamber.

11. The juicing assembly according to claim 6, wherein the juice inlet is a vertical or diagonal opening.

12. The juicing assembly according to claim 6, wherein the inner wall of screw body is provided with a V-shaped groove, the tip of the V-shaped groove communicates with the juice inlet, and the opening of the V-shaped groove faces and communicates with the juice collection chamber.

13. A juicer, comprising a main unit with a built-in power device, a juicing assembly, a feeding bin, and a juicing cylinder, wherein:
the juicing assembly comprises a screw body, the outer wall of screw body is provided with threads, the inner cavity of screw body is provided with a juice collection chamber, and a plurality of juice inlets communicating with the juice collection chamber are spaced on the outer wall of screw body;
the juicing cylinder is provided with a juicing chamber for accommodating juicing assembly, the juicing assembly is disposed inside the juicing chamber, and a squeezing area is formed between the outer wall of screw body and the inner wall of juicing chamber;
the juicing cylinder is provided with a residue outlet communicating with the squeezing area;
the juicing cylinder is disposed at a juice discharging port that communicates with the juice collection chamber;
the juicing cylinder is disposed on the main unit, the power component of power device runs through the juicing cylinder and connects to the screw body, and the power device drives the screw body to rotate;
the feeding bin is disposed on the juicing cylinder and located above the screw body, and communicates with the juicing chamber.

14. The juicer according to claim 13, wherein an installation chamber is provided at a position on the main unit corresponding to the juicing cylinder, the side wall of main unit is provided with a first gap and a second gap that communicate with the installation chamber, the juicing cylinder is disposed in the installation chamber, and the residue outlet is disposed in the first gap, and the juice discharging port is disposed in the second gap.

15. The juicer according to claim 13, wherein the inner wall of feeding bin is provided with at least one convex rib for preventing the rotation of and crushing the food in the feeding bin.

16. The juicer according to claim 13, wherein slots are provided at interval at the open position of juicing cylinder in the juicing chamber, blocks are provided at interval at the lower port of the feeding bin, and those blocks are inserted into the slots to tightly clamp the feeding bin and juicing cylinder together.

17. The juicer according to claim 13, wherein the juicing assembly further comprises a pressure plate, a cutting blade and a transmission shaft, the transmission shaft disposed in the inner cavity of screw body is integrally formed with the screw body, and the head of transmission shaft runs through the screw body and extends outward;
the cutting blade is rotatably disposed on the pressure plate, and the pressure plate is connected to the screw body and located above the screw body;
the head of transmission shaft runs through the pressure plate and is connected to the cutting blade;
the power component of power device is connected to the transmission shaft, and the rotating transmission shaft enables the synchronous rotation of screw body and cutting blade.

18. The juicer according to claim 17, further comprising a bolt and a wear-resistant sleeve, wherein the inner cavity of wear-resistant sleeve is provided with a connecting cavity that fits the shape of the head of transmission shaft;
the pressure plate is provided with a socket, the wear-resistant shaft sleeve is disposed inside the socket, the upper end of the wear-resistant shaft sleeve is provided with an upper connecting clamp ring, the bottom of the cutting blade is provided with an upper connecting clamp cavity that fits the shape of the upper connecting clamp ring, the upper connecting clamp ring is inserted into the upper connecting clamp cavity, and the bolt runs through the cutting blade to lock the wear-resistant shaft sleeve, so as to connect the wear-resistant shaft sleeve with the cutting blade;
the head of transmission shaft is inserted into the connecting cavity, and the bolt locks the head of transmission shaft to connect the cutting blade, pressure plate, and screw body together.

19. The juicer according to claim 13, further comprising a blocking cover, wherein the the cutting blade is provided with a first bolt hole, the wear-resistant shaft sleeve is provided with a second bolt hole, the head of screw body is provided with a third bolt hole, and the bolts pass through the first bolt hole and the second bolt hole in sequence and are locked on the third bolt hole, and the blocking cover is disposed at the position of the first bolt hole and closes the first bolt hole.

20. The juicer according to claim 13, wherein the juice inlet is a vertical opening, the inner wall of screw body is provided with a V-shaped groove, the tip of the V-shaped groove communicates with the juice inlet, the opening of the V-shaped groove faces and communicates with the juice collection chamber, and the width of juice inlet is smaller than that of the opening of the V-shaped groove.
